(19) United States
(12) Patent Application Publication
(10) Pub. No.: US 2013/0246181 A1
(43) Pub. Date: Sep. 19, 2013

(54) System and Methodology for Dynamic and Targeted Advertising in Vehicles and in Fixed Locations

(71) Applicant: Charles B. Lobsenz, Great Falls, VA (US)

(72) Inventor: Charles B. Lobsenz, Great Falls, VA (US)

(21) Appl. No.: 13/418,382

(22) Filed: Mar. 13, 2012

(51) Int. Cl. G06Q 30/02

(52) U.S. Cl. 705/14.63; 705/14.62; 705/14.49

(57) ABSTRACT

A novel system and methodology for providing targeted advertising in vehicles or in fixed locations. The system is comprised of a centralized system interacting with one or more databases and a plurality of dedicated devices located in vehicles or in fixed locations which communicate with the centralized system to receive ads for display and report vehicle/fixed location data to the centralized system. The centralized system functions to (i) interact with advertisers so that advertisers can make ad buys; (ii) interact with custodians of fixed displays so that they can make their displays available for advertising; (iii) receive vehicle/location data to populate databases with information used to price and allocate available advertising opportunities; (iv) transmit advertising data to displays; and (v) calculate, reconcile, report and/or process payments due from advertisers and payable to custodians of fixed displays.

### FIELD OF THE INVENTION

The present invention is directed generally to advertising systems and services, and more particularly, to an online system and methodology for managing an advertising service where advertisements are placed in vehicles such as automobiles.

### BACKGROUND OF THE INVENTION

The advertising industry and its many and varied forms and types of advertisements have been in existence for quite some time. As individuals go about their daily activities they are exposed to a plethora of advertisements in many different locations, formats and contextual environments. Advertisers and those in the industry have noted that the most effective ads are those that are as specifically targeted to those individuals or entities most likely to be interested in the product, service or other offering which is being advertised.

With the advent of the internet and all of the life-changing effects that it has had on so many different aspects of life, it is no surprise that the web is fertile ground for advertising. This is due in large part to the sheer number and variety of people which use the web so frequently. But perhaps more importantly, web based advertising in certain contexts is perceived as one of the most effective methodologies available today.

Web based advertising campaigns often achieve a demonstrated high degree of return on investment precisely because of the targeting that can be obtained though the use of technology. For example, search engine advertising can be targeted to search terms entered and web page advertising can be targeted to match or otherwise be relevant to the content at specific web pages. Also, tracking of advertisements on the web including metrics such as click-throughs and page views, allows advertisers to accurately measure ROI, and perhaps more importantly, make strategic adjustments to advertising campaigns to obtain better or different results.

As a result of the perceived and actual value provided by advertising, including not just direct sales but also less tangible but still valuable benefits such as brand awareness, advertising has become more and more ubiquitous throughout society and we are exposed to more and more ads in more and more places and contexts that used to be ad-free. For example, some newly utilized advertising contexts include ads placed on pull down trays on airlines and ads placed on supermarket shopping carts. Another recent trend has been to deploy ads which are shown on digital displays such as television monitors on floors of highly trafficked areas such as restaurants, malls, etc. These floor based ads may alternatively be static such as through the use of a colourful attention grabbing sticker affixed to the floor.

Accordingly, it is just a fact of life that advertising is prolific within today's society. New advertising contexts and the roll out of advertisements in places where they had never been are driven, to a large extent, by the fact that they present new revenue opportunities for those controlling the space where this advertising is presented. Also, some of these new contexts provide the means for very effective advertising opportunities whether because the ads are being presented to a captive audience or because they are being seen by large numbers of people, or both, or for other reasons.

One environment in which advertisements have not proliferated to date is on vehicles such as privately owned automobiles, commercial vehicles (such as trucks and buses) and fleets of vehicles such as taxi cabs and rental cars. This is somewhat surprising since many of the key ingredients to an effective return on investment for advertising dollars in this context are present. For example, with today's congested roads and highways, individuals in cars are often exposed to viewing other cars around them for long periods of time. During a morning commute, for example, a driver on a congested one lane road in a metropolitan area may view the back of the car in front of him or her for 30 minutes to an hour or more depending on traffic patterns and the length of the commute.

While vehicles such as privately owned cars may typically have affixed items like bumper stickers, college stickers and license plate holders with clever sayings, commercial advertising on these types of vehicles is virtually non-existent. While there are some exceptions, such as Mary Kay cosmetics advertising or other multi-level marketing advertisements on privately owned automobiles, for the most part, the vast opportunity for commercial ads on these vehicles that are seen by so many people almost every day has been largely ignored.

There are known businesses that provide customized vehicles which contain an advertisement such as a billboard-like structure contained on the bed of the vehicle. In typical fashion, these vehicles drive around metropolitan areas during the day and in the evening usually according to pre-determined routes in order to maximize exposure to these moving advertisements. These services suffer from a number of drawbacks such as the advertisements being static and being expensive.

Further, while taxi fleets often have financial arrangements with advertisers and intermediaries whereby large display ads are placed on the vehicles such as via a custom display platform attached to a taxi roof, these advertisements are also static. Thus they suffer from a number of drawbacks including being less than engaging from a viewer point of view, being expensive, and being fixed in terms of the advertising content available without manual physical replacement of the ad.

Owners of privately owned automobiles and entities owning fleets of vehicles such as taxis and rental cars have thus not to date leveraged an opportunity to monetize advertising space available on these vehicles. Because these vehicles are often present in highly trafficked areas where many people see them, they reflect a potential valuable advertising platform which has not yet been fully exploited. Further, because these vehicles are constantly on the move, the same vehicles can be seen by many different people in many different areas throughout the typical day.

Perhaps even more importantly, as with some forms of internet based advertising which command high dollar per impression costs, advertising based on vehicles such as privately owned cars can be highly targeted and tracked. In today's vehicles, various data respecting the speed and location of the vehicles could be easily tracked and made available to a central database wirelessly. Current location could be tracked via GPS. Current speed (and other data such as vehicle diagnostic data) could be made available through a wired or wireless interface based on data captured and reported by functionality such as Engine Control Units (ECUs) or other similar platforms present in most automobiles manufactured today. In addition, there exists technology to track user driving habits such as average speeds, typical routes travelled, etc. This data could be combined with data such as that available in databases such as typical daily traffic volumes on roads at various times during the day to calculate information such as an expected daily volume of cars passed for each specific vehicle. In other words, using data from a specific vehicle such as typical routes travelled and combining that with known data about traffic volume, can provide valuable information regarding how much “exposure” a specific vehicle receives during a typical day.

As another example, using GPS data, it is possible to determine typical or “average” times at a location for a specific vehicle during a typical day. So for example, based on reported data, a vehicle could be determined to spend 9 hours of the typical day at a parking lot at the driver's work location, 1 hour of a typical day in motion commuting between home and work and back, 1 hour of a typical day at a shopping mall in the evening and the remainder of the day in a parking space outside the driver's apartment. Separate data sets for the same car could be obtained for weekend days which would reflect different typical locations. Of course, all of this is and should be subject to the knowledge, acknowledgement and permission of the driver in terms of agreeing that this data may be captured and shared.

It is believed that the ability to exploit this valuable data in the context of vehicle based advertising has been limited for a number of reasons. It is further believed that one key reason for this is the lack of a marketplace and/or platform though which vehicle owners can make their vehicles available for advertising along with the ability to automatically and efficiently serve, track and process payments associated with ads. Further, there is no existing marketplace through which advertisers could make ad buys according to specialized demographic information regarding vehicles which are available for ad placement.

Based on the foregoing, it should be apparent that widespread advertising on vehicles such as privately owned automobiles is an untapped opportunity for advertisers. Even more compelling, these ads can be highly targeted, ubiquitous and dynamically served as described according to the present invention. From the point of view of the owners of the vehicles which can be used to serve these advertisements according to the present invention, there is a unique revenue opportunity such that vehicle owners (or owners of fleets of vehicles) can receive monetary or other compensation in return for allowing their vehicle(s) to be used for advertising according to the teachings of the present invention.

### SUMMARY OF THE INVENTION

It is thus a primary object of the invention to provide a system and methodology for advertising via movable vehicles such as cars and fleet vehicles including taxis and rental cars which overcome the limitations of the prior art and which leverages the unique nature of these vehicles to provide highly targeted and ubiquitous advertising opportunities.

It is another object of the present invention to provide a system and methodology for advertising through which owners of vehicles such as privately owned automobiles and fleet vehicle owners can derive compensation in return for making their vehicles available for advertisements.

It is yet another object of the present invention to leverage the unique data available in vehicles such as automobiles to provide and track highly targeted advertising opportunities. Such data may include, for example, present location, present speed, average speed, typical routes travelled, and typical vehicle location at various times during the typical week.

It is a further object of the present invention to leverage data which may be available externally in combination with specific vehicle data to further target advertising. For example, external databases containing typical traffic volumes on various roads and highways can be combined with typical driving routes obtained from specific vehicles to determine the typical exposure that each such vehicle has to “eyeballs” during a typical day.

It is a still further object of the present invention to provide functionality whereby advertisers may interact with a centralized system to make targeted advertising purchases based on aggregate or individual vehicle data available in a centralized database. Such aggregate data may be collected based on aggregating information associated with individual vehicles such as that described above. In one embodiment of the present invention, this data is wirelessly transmitted and uploaded from the vehicle to a centralized system for processing and aggregation. Further, in a preferred embodiment of the present invention, the functionality for allowing advertisers to make advertisement purchases is via a web based interface communicating with a centralized system and database.

It is a yet further object of the present invention to provide functionality whereby vehicle owners may interact with a centralized system to make their vehicles available for advertising and determine actual or likely compensation to be provided in return for making the vehicle available for advertising. In a preferred embodiment of the present invention, the functionality for allowing vehicle owners to make their vehicles available is via a web based interface communicating with a centralized system and database.

It is a still further object of the present invention to provide a dedicated device which may be located within or on the outside of a vehicle and which functions to implement one or more of the following: receiving advertising data from a centralized system, displaying advertisements, obtaining vehicle data such as location data and speed data from the vehicle, and/or reporting such vehicle data to a centralized system.

It is yet another object of the present invention to provide functionality which may be embedded within a fixed platform such as a home appliance or other item present in a home and whereby such functionality allows for communication with a central system which serves ads to the fixed platform via the said functionality based on various targeting characteristics such as location, type of device, demographic data provided by the user of the home appliance or other item and external databases.

These and other objects of the present invention are achieved through a novel system and methodology for providing targeted advertising. According to a preferred embodiment of the invention, the system is comprised of a centralized system interacting with one or more databases and a plurality of dedicated devices located in vehicles or in a fixed location which communicate with the central system to receive ads for display and report vehicle or fixed location data to the centralized system. In a preferred embodiment, the centralized system functions to (i) interact with advertisers so that advertisers can make ad buys; (ii) interact with vehicle owners so that vehicle owners can sign up to make their vehicles available for advertising and provide data associated with their vehicle and other demographic data in connection therewith; (iii) receive vehicle data from vehicles to populate one or more databases with individual and aggregate information which can be used to price and allocate available advertising opportunities and for other purposes; (iv) transmit advertising data to vehicles via the aforementioned dedicated devices associated with each vehicle; and (v) calculate, reconcile, report and/or process payments which may be due from advertisers and which may be payable to vehicle owners based on ads served or some other agreed to basis.

From the advertiser's perspective and according to one embodiment of the present invention, advertisers may log into a web based application which communicates with the centralized system so that the advertisers can search for, view and purchase advertising opportunities. By way of example, an advertiser may search for an ad buy in the metro Washington, DC area where at least 50 vehicles are available and wherein each of these vehicles is expected to be seen by at least 8000 other vehicles during a typical weekday. Once those search results are presented, the advertiser may view the pricing associated with these opportunities and then make an ad purchase. The advertiser could select a start date and end date for the campaign and during that time frame, the centralized system will serve the desired ads to the selected number of vehicles via the dedicated devices located in or on the vehicles.

The advertiser may further configure the campaign by selecting specifics such as the type of vehicles (e.g. SUV, truck, economy car), the specific expected locations of the vehicle (e.g. typically driving on Rt. 7 weekday mornings, typically parking in Main Street mall on weekend afternoons), times for ads to be displayed (e.g. only during the hours from 10-2) and other selections based on vehicle data obtained from either the vehicle owner as provided to the centralized system (at sign up and/or at a later time) or obtained though the dedicated device in vehicles periodically reporting driving data to the centralized system which is stored in associated databases.

From the vehicle owner perspective, the vehicle owner may access a website/web based interface to sign up for the advertising service and make his or her vehicle available for advertising. At the time of sign up, the owner may provide demographic data possibly including banking information which allows the service to make payments to the owner periodically. The owner may also provide other data such as make and model of the vehicle, driving habits, locations within or on the vehicle available for the dedicated device to be located, typical routes driven, where the vehicle is typical garaged/parked, etc.

The dedicated device of the present invention preferably includes a display component which can display ads in colour and such display may be in the form of an LED type display or in the form of a TV like display capable of displaying full motion video and/or static images. The device preferably also includes the ability to receive either wirelessly or via wired connection, vehicle data from the vehicle such as average and current speed data. Location data may be provided to the dedicated device either through an integrated GPS receiver within the device or from a GPS device otherwise present within the vehicle. The dedicated device preferably communicates with the centralized system wirelessly though, for example, a connection via a data network such as 4G data networks presently available in the United States.

For example, the vehicle may have the built in ability to provide a WiFi or similar “hot spot” within the vehicle or, alternatively, for example, network access may be made available within the vehicle through a smartphone or other portable “hot spot”. In this way, the dedicated device can report vehicle data to the centralized system as well as receive ads from the centralized system either from time to time in a batch mode or in real time for immediate or near-immediate display.

Physically, the dedicated device may be mounted, for example, on the back window deck of a typical passenger vehicle such that the display is viewable by drivers of other vehicles though the rear window. Of course, other locations within or outside of the vehicle are also possible. The dedicated device may also include a battery power source such that the display may be activated and/or position data be detected and reported to the centralized system even when the vehicle engine is not running such as when the vehicle is parked including when no driver is present within the vehicle.

### BRIEF DESCRIPTION OF THE DRAWINGS

FIG. 1 is a diagram illustrating the overall architecture of the system of the present invention and the various components thereof according to a preferred embodiment of the present invention;

FIG. 2 is a more detailed view of the functional components comprising the central control system (CCS) of the present invention in a preferred embodiment thereof; and

FIG. 3 is a diagram illustrating the functional components of the dedicated vehicle device (DVD) of the present invention which is placed in vehicles according to a preferred embodiment thereof.

### DETAILED DESCRIPTION OF THE INVENTION

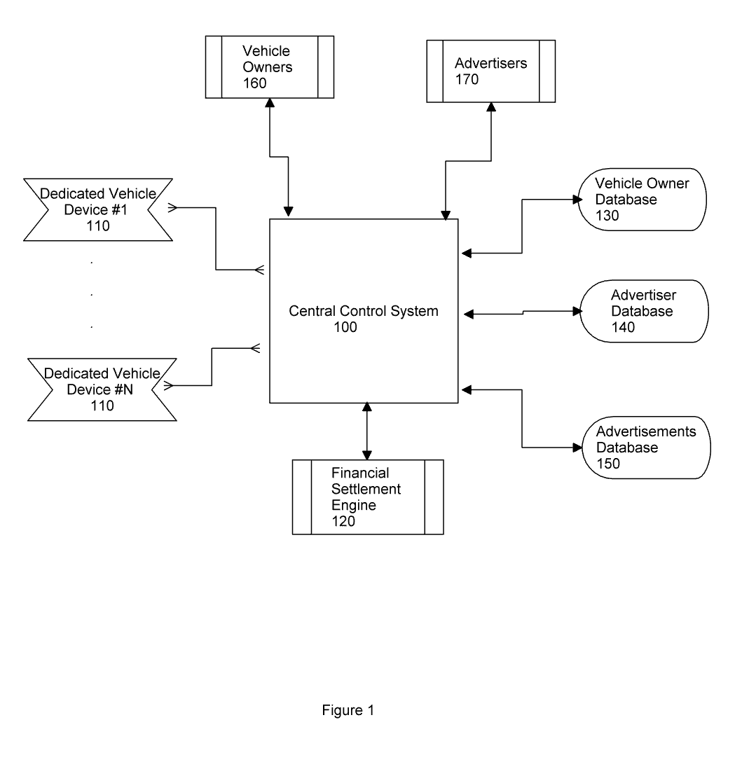

With reference to FIG. 1, the system of the present invention according to a preferred architecture thereof is now described. As discussed above, the heart of the system is central control system 100. Central control system 100 is preferably implemented as a software solution resident on a robust, redundant and powerful computing platform. Central control system 100 communicates with one or more physical storage media housing various databases. These databases include at least a vehicle owner database 130, advertiser database 140 and an advertisement database 150.

Vehicle owner database 130 may include all or some portion of the data associated with the owners of vehicles which have elected to make their vehicles available for advertising. For example, vehicle owner database 130 may include demographic information for all vehicle owners including items such as name, address, contact information, vehicle(s) made available under the program, bank account information for payment processing and any restrictions or preferences associated with what or when the vehicle owner is willing to advertise. Vehicle owner database 130 may also include driving habit information associated with each vehicle owner and/or driver.

Such information may include home location, work location, typical driving routes and times/days these are typically travelled etc. This information may be originally provided by vehicle owners using the vehicle owner application 160 (discussed below) when signing up for the service and/or updated this way periodically. Alternatively or in addition, data may be derived and uploaded periodically to central control system 100 by dedicated vehicle devices 110 (discussed below) as driving habits are determined and as they may vary over time. Preferably, any automatic upload of data respecting individual driving habits in aggregated and/or subject to the acknowledgement and approval of the driver and/or vehicle owner.

This data may include items that can be determined over time though the use of information made available to dedicated vehicle device 110. This may include, for example, speed data from the vehicle ECU or similar, location data from a GPS receiver (either within dedicated vehicle device 110 or external to it), temperature data from a thermometer (again, either internal or external to dedicated vehicle device 110), etc.

The system of the present invention preferably also includes advertiser database 140 which may be written or read by central control system 100. This database includes information associated with advertisers which are registered to make advertising buys under the program. For example, this information may include company name, contact person, address, financial information for accounts payable, preferences regarding ad buys, historical data regarding ad buys previously made, agreed to costs associated with advertisements made by specific advertisers and other information relevant to managing the program's relationship with its advertisers.

The system of the present invention further includes advertisement database 150 which stores digital content representing advertisements or other information which is to be served under the program as controlled by central control system 100 and as made available in-vehicle by dedicated vehicle device 110. Advertisers may interact with central control system 100 via advertiser application 170 which is preferably web based in similar fashion to vehicle owners application 160. Thus, using advertiser application 170, advertisers can, for example, upload advertisements to advertisements database 150 as well as make ad buys and provide and update advertiser related information and preferences.

The system of the present invention preferably also includes financial settlement engine 120. This component serves to settle financial transactions associated with the advertising program(s). This includes calculating and processing payments due from each advertiser based upon agreed to amounts as well as calculating and processing payments due to each vehicle owner participating in advertising programs, again, at agreed to rates.

Rates for paying vehicle owners may be based, for example, on a monthly amount regardless of the number of ads served, on a per ad basis, on a per mile driven basis, based upon the type of vehicle driven, the location(s) that the vehicle is typical driven/parked or any other basis determined by the program operator. Rates for charging advertisers may be based, for example, on a fixed monthly amount, on a per ad impression basis, on a custom package of impressions as selected by an advertiser such as types of vehicles, geographic locations of vehicles, typical miles driven, etc. or any other basis determined by the program operator.

Financial settlement engine 120 may connect with one or more financial institutions, gateways or other systems or services which allows for payments to be made via electronic transfer to and from vehicle owners and advertisers.

Finally, central control system 100 communicates with a plurality of dedicated vehicle devices 110 which are discussed in greater detail below. These devices 110 are preferably allocated one per vehicle (although there may be more) and are placed somewhere in or on each vehicle. Dedicated vehicle devices 110 preferably include a display component and may also include a GPS receiver, temperature sensor, input to accept data from vehicle based subsystems such as an ECU or other peripheral systems located within the vehicle. Communication between dedicated devices 110 and in-vehicle peripherals and/or ECU may be via a wired connection or via a short range wireless protocol such as Bluetooth. Communication between dedicated vehicle devices 110 and central control system is preferably via longer range wireless protocol such as a 3G or 4G data network that permits data to be transferred back and forth between dedicated vehicle devices 110 and central control system 100.

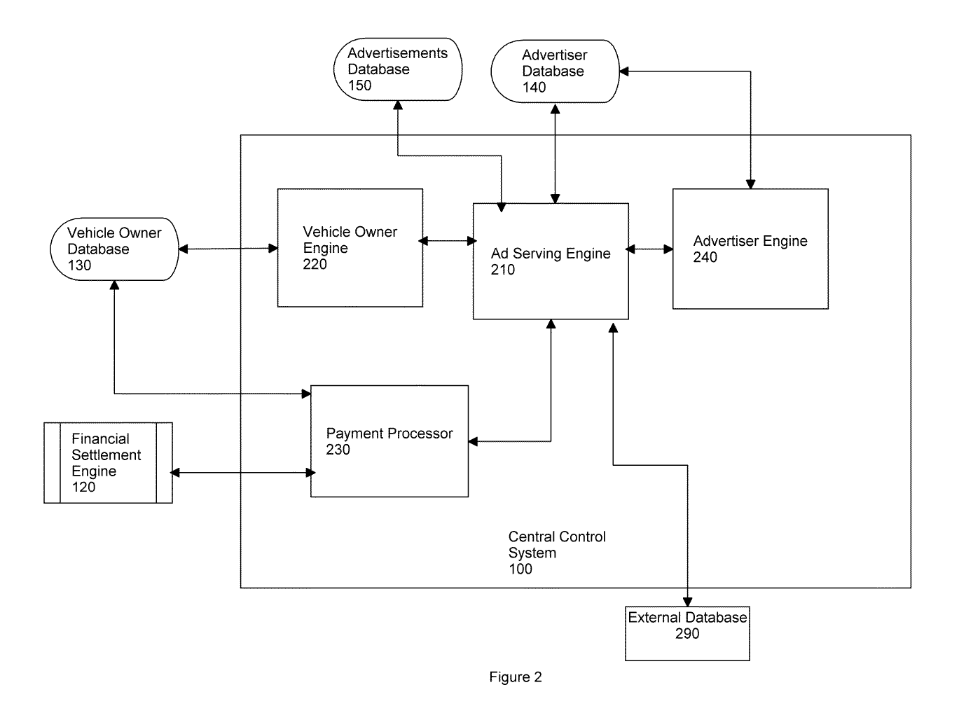

Turning now to FIG. 2, a more detailed discussion of central control system (CCS) 100 and its various components and functions is now provided. This discussion is provided in the context of some of the key operational characteristics of CCS 100 and some of its primary functionality.

### Vehicle Owner Signup and Interaction

According to a preferred embodiment of the invention, CCS 100 provides functionality to allow new vehicle owners to sign up for the advertising service. Preferably, this is accomplished through a web based interface communicating over the internet or some other known communications protocol such that information can be passed back and forth between a vehicle owner at his or her workstation and CCS 100. In particular, vehicle owner engine (VOE) 220 component of CCS 100 controls these processes which include initial owner signup as well as continued management of the vehicle owner relationship including those matters related to both account/financial issues and interaction with dedicated vehicle devices 110 associated with each owner account.

When a new vehicle owner signs up, some or all of the following information may be provided by the user and captured by VOE 220 to set up an account: name, address, phone number, other contact information, financial information including bank and credit card information, vehicle(s) make/model/year, expected location within or outside of vehicle(s) for placement of DVD 110, limitations/preferences for ads to be served to owner's DVD 110, and driving habit information such as typical location of vehicle at night and during the day as well as typical/expected driving routes.

In connection with the creation of an account for a new vehicle owner, the above information as well as other/additional information associated with the owner is acquired by VOE 220 and stored in vehicle owner database (VOD) 130 as an initial record or set of records for the account. Additional data associated with the account may then be obtained over time from either or both of the DVD 110 associated with the owner and/or through the web interface as input by the owner. In the former case, automated driving related data is typical and in the latter case, updated owner account data and/or preferences is typical.

### Receipt and Use of Vehicle Based Data

As referenced above, as vehicle owners drive their vehicles containing DVD 110, additional data relating to that vehicle may be automatically obtained (preferably subject to driver/vehicle owner knowledge and assent) and automatically and periodically uploaded wirelessly by DVD 110 to CCS 100 and processed by VOE 220 for storage in VOD 130. Examples of data that may be obtained via DVD 110 in this context include current/real time location (via GPS either integrated in DVD 110 or external to DVD 110), current speed (via ECU or other functionality and shared wirelessly or through a wired connection with DVD 110), recent routes travelled, times at various locations (e.g. most hours where the vehicle is located such as home garage at night and work parking lot during day), average speed over various times, current or average temperatures (via sensor internal or external to DVD 110) and other information which could be valuable to advertisers in connection with the subject advertising service.

Data from external databases 290 may also be obtained and used by ad serving engine 210 to target advertisements. For example, external database 290 may be a commercially available database with traffic volume data (Route 7 from 8-9 am typically has an average of 15,000 cars pass by some fixed point). This data may be combined with typical routes travelled information for particular vehicle owners to make a calculation regarding the expected/typical number of vehicles which travel the same route(s) as the individual vehicle owner on a typical day. If the vehicle owner agreed to park on the side of the road or in a lot adjacent to the road for some particular period of time during the day, the number of vehicles expected to be passed could be obtained and used for targeting advertising as well as for pricing payments to be made to vehicle owners or to be paid by advertisers. Other databases 290 with other external data could also be employed.

The above and other data may be uploaded at a certain times or times during the day, at periodic time increments (e.g. every 15 minutes) or only when the vehicle owner initiates a data transfer (e.g. by pushing a button on DVD 110). As the above data is captured and transmitted to CCS 110 for storage in VOD 130, the data may be aggregated and analysed for use in creating and pricing advertisement packages available to advertisers as discussed in further detail below.

### Advertiser Registration and Advertisement Buys

In a similar fashion to that described above with respect to vehicle owners, advertisers desiring to make advertising buys using the service will register through a web based interface but in this case, advertiser engine 240 component of CCS 100 manages the processing. At the initial advertiser registration, various information may be collected to set up an advertiser account. Examples include company name, contact information, expected monthly spend, advertising preferences, bank account information and amount of initial deposit for advertising costs.

Again, this information is processed by advertiser engine 240 so as to set up one or more records associated with the advertiser account for storage in advertiser database 140. As the advertiser makes additional advertising buys, historical information may be obtained and processed to, for example, make suggestions for potential ad buys for the advertiser in the future. This information may be stored in advertiser database 140.

In addition, advertisers may upload advertisements that they desire to have served to DVDs 110. This is preferably accomplished under the control of advertiser engine such that all available ads associated with that advertiser are stored in advertisements database 150. Advertisements may be uploaded, stored and served according to many known digital formats such as those associated with still pictures, video and others.

Once advertisers have an account set up, they may make buys of advertising in connection with the advertising program made available through the systems and methodologies of the present invention. Based on data acquired from vehicle owners either manually through a web interface as described above, aggregated data can be generated and the various advertising opportunities/packages made available through a web based interface to advertisers for selection. For example, aggregated data such as that may be generated from data derived from vehicle owners as described herein, can make the following types of targeted advertising packages available:
Within a particular geographic driving area
A specific number of vehicles
Vehicles of only a certain make, model or year
Vehicles that only drive a certain number of miles each day
Vehicles that are present at a certain location (e.g. shopping mall) for a minimum number of hours per day
Vehicles that only drive a specific route or some portion thereof on specific days
Vehicles that only drive within a certain average speed range
Vehicles that place their DVDs 110 only in a certain location on their vehicle (e.g. rear window deck, bumper, etc.)
   Various other selection criteria could also be used based upon the targeted data obtained from vehicle owners. In addition to these types of constraints, advertisers may also control their ad purchases through other criteria such as total number of ads served, maximum spend over some period of time (monthly, weekly etc.), days/times for ads to be served, etc. So, therefore, it can be seen by one of ordinary skill in the art that the present invention provides a unique opportunity for targeted advertising according to a wide range of criteria so that ad spend can be maximized. Given the web based nature of the system, advertisers can also track success of ads based on desired criteria such as store traffic, purchases etc. in connection with various ad campaigns and, if desired, change ad and spend constraints as described above over time to maximize effectiveness.

### Serving Advertisements

In connection with the present invention, advertisements are served by CCS 100 (and in particular by ad serving engine component 210 accessing available ads in advertisement database 150) to DVDs 110 for display. In a preferred embodiment, these advertisements are transmitted wirelessly to DVDs 110 in “batch mode”. This means that multiple ads are sent at one time for storage in local storage at DVD 110. A schedule for determining which ads should be displayed when and how frequently may also be transmitted to DVD 110 either independently or with each set of ads delivered.

Preferably, DVDs 110 are addressable as is known in the art such that ads (or any other communication between CCS 100 and each DVD 110) may be specifically sent to individual or selected groupings of DVDs 110. This is desirable so that ad display selection and frequency can be controlled to be consistent with purchases and selections made by advertisers. Preferably, DVDs 110 may also wirelessly send reports regarding ads actually served on DVD over pre-determined time periods back to CCS 110 (in particular ad serving engine 210) so that billing and reconciliation can occur based on collective ads served. This latter action is under the control of payment processor 230 and is described in further detail below.

In any event, ads are obtained from advertisements database 150 and transmitted to applicable DVDs 110 based upon all of the advertising buys made by advertisers over specific time periods. In a typical context, batches of ads from different advertisers along with the frequency that ads should be displayed on the DVD 110 are transmitted to DVDs 110. Other related information associated with each ad may also be included in the transmission to the DVDs 110 such as restrictions (typically dictated by advertisers) on locations, times, speeds etc. during which each specific ad may be displayed. Each DVD 110, given the availability of ads and data regarding when each ad should be displayed in local storage, can now operate independently with or without ongoing communication with CCS 100 to display ads up until the time that DVD 110 receives new/different ads and/or instructions from ad serving engine 210 of CCS 100.

### Payment Processing

Payment processing and settlement is accomplished by payment processor 230 of CCS 100. This component serves the function of reconciling all payments to be made and received in connection with the advertising service of the present invention.

With respect to advertisers, payment processor 230 may generate invoices for any fees owed by advertisers either in connection with actual ads served or otherwise. For example, advertisers may be charged and invoiced a base monthly fee for program participation. Invoicing for this as well as specific ad impressions is managed by payment processor. With respect to specific ad impressions, payment processor 230 accesses information regarding ads intended to be served and/or actually served via ad serving engine 210. In the case of ads actually served, this data is obtained via the reports uploaded by the DVDs 110 to ad serving engine 210 as discussed above. In any event, pricing, such as per ad costs and overall campaign costs should be consistent with that quoted to advertisers when making the buy via advertiser engine 240 as discussed above.

With respect to vehicle owners, payment processor 230 functions to reconcile payments due to owners based on revenue expectations/quotations made available to vehicle owners at signup or when accepting to participate in a specific advertising campaign or set of campaigns under the control of vehicle owner engine 220. For example, vehicle owners may be promised a per impression payment amount, a fixed periodic fee regardless of number of ads served, a fee based on the number of miles driven or time vehicle is at a specific location or some combination of these or other factors associated with how the vehicle is driven or parked. In any event, payment processor 230 periodically calculates and reconciles payments due to vehicle owners based on these criteria. Payment processor 230 may communicate with an external financial settlement engine 120 which may either be or be in communication with one or more financial payment gateways so as to automate payments either to be made or received under the program electronically through, for example, ACH or other electronic transactions into or out of vehicle owners and advertisers bank accounts.

### Dedicated Vehicle Devices

Dedicated vehicle devices 110 are preferably located one to a vehicle in vehicles registered in the advertising program of the present invention. DVDs 110 may be located anywhere feasible either inside of or outside of the vehicle. One possible location is on the back deck by the rear window of the vehicle with the display facing backwards for viewing by vehicles and individuals located behind the vehicle holding the DVD 110. Another possible location is mounted to a side rear window again with the display facing out. In terms of exterior locations, DVD must be weatherproofed and secured to the vehicle well such that it does not come off during vehicle movement etc. Possible external locations include on the front or rear bumper of an automobile, on the back roll up door of an 18-wheeler or other truck, etc.

It will be obvious to one of ordinary skill in the art that the display, housing and componentry must be custom selected and designed for each potential location inside or outside of the vehicle. Another very important issue is any legal or regulatory issues associated with the use of DVDs 110 and displays on vehicles either now existing or later enacted/adopted. Location and operation of DVDs 110 must comply with these requirements which may be enacted for safety or other reasons. For example, if particular displays are prohibited in moving vehicles, it is possible to restrict the operation of displays in DVDs 110 only when the vehicle is either stopped or moving at a speed which is lower than a pre-determined value. Also, DVDs 110 could be restricted to operating only on certain roads and/or only within certain geographic areas. Again, each of these constraints can be designed such that operation always occurs within the bounds of the law and regulations.

All of these constraints can be imposed because the data such as location data and speed data is available to DVD 110 as described above. By way of example, DVDs 110 may be restricted via commands/data supplied by CCS 100 to only display ads when the vehicle is stopped, parked, engine off within a narrow geographic range such as at a specific shopping mall. In this case a battery would power DVD 110 and the display could be operative to display ads to, for example, passers by in the mall parking lot while the vehicle is parked there.

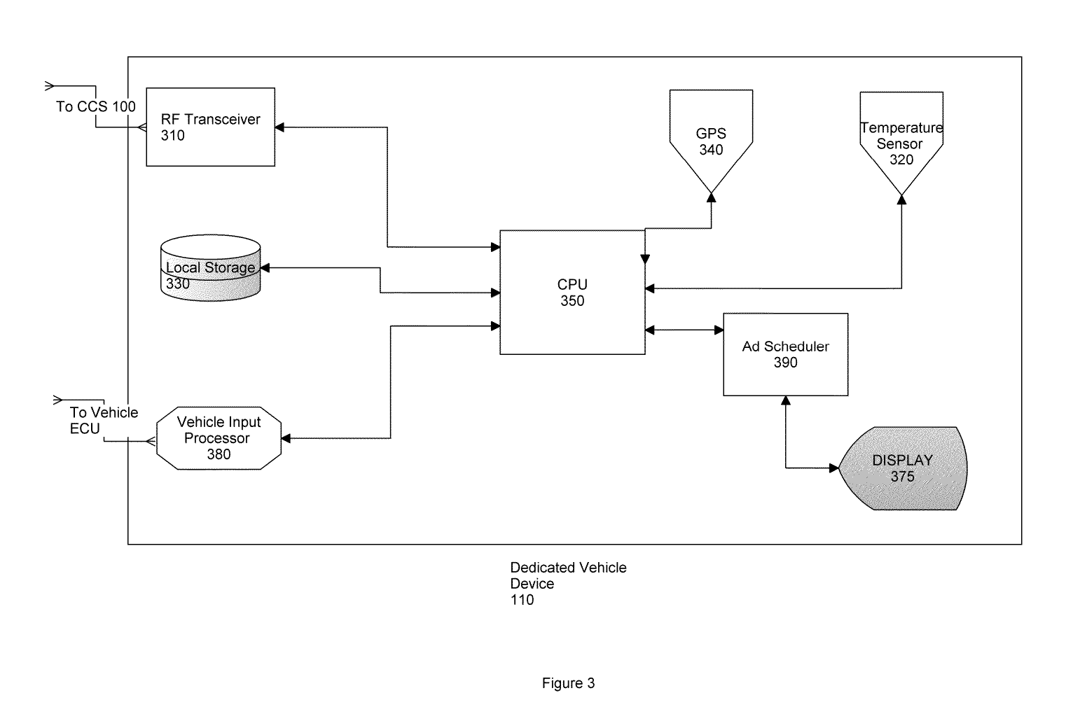

Turning now to the specific components which may be present in DVD 110 as shown in FIG. 3, DVD 110 may contain a number of components designed to allow flexibility and functionality in connection with the advertising service of the present invention. DVD 110 may be designed for use either internal to the vehicle or external to the vehicle. In the latter case, a suitable environmental housing is necessary to address exposure to water and other weather related elements. DVD 110 may include CPU 350 which controls the software based processes and other operations of DVD 110.

Various external components may be either included as an integral part of DVD 110 or external to DVD 110 but in communication with DVD 110. In the case of FIG. 3, two components designed to provide data for use by DVD 110 are included. GPS 340 is a global positioning satellite receiver as is known in the art and which is capable of providing precise positioning data as well as current speed and altitude data to CPU 350 in connection with processing. Temperature sensor 320 may provide internal and/or external air temperature for use by CPU 350. Again, other sensors or devices capable of providing data to DVD 110 may also be used to accentuate the capabilities and targeting ability of the advertising program of the present invention as discussed above. While GPS 340 and temperature sensor 320 are shown as internal to DVD 110, it is also possible for these to be components which are a part of, for example, an automobile or separate components altogether.

DVD 110 also includes RF transceiver 310. This component provides two way communication with CCS 100 and other devices and systems through a wireless connection. Thus any device or system with a connection to the internet or through direct wireless connection may be selectively in communication with DVD 110 as desired. RF transceiver, may be for example, a radio transceiver using a standard 4G wireless protocol such as WiMAX or LTE. It is preferable that RF transceiver also have the capability of short range communication possibly using a secondary radio so as to allow communication with other in-vehicle systems such as GPS, ECU data and possibly a WiFi hotspot (which could take the place of and/or supplement the need for the long range radio capability discussed above).

DVD 110 also includes local storage 330 which may be used to store operating system software, advertisement data received via download from CCS 100 and scheduling information for ads, for example. Vehicle input processor 380 provides the capability to process information which may be received from in-vehicle systems such as GPS, speed data, temperature data, engine on/off status, etc. This information may be received either via a wired or a wireless connection.

Ad scheduler 390 component of DVD 110 provides functionality which determines which ads in local storage 330 are displayed and when. Typically this information is provided by CCS 100 but may also be provided manually though one or more user input methodologies (such as keyboard, buttons, etc.) as is known in the art local to DVD 110. Ad scheduler 390 may also serve to manage reporting of ad impressions actually made by DVD 110 and provide this data via CPU 350 to local storage 330 and then eventually uploaded to CCS 110 either on a pre-set schedule or as requested by CCS 100.

Finally, DVD 110 contains or interacts with one or more display units 375. Display unit 375 serves to display ads which are available in local storage 330 or which are sent by CCS 100 and displayed in real time or close to real time. Display 375 is preferable a small flat screen type display which may either be mounted upon or integral to a part of the vehicle. For example, display 375 could be a very thin LCD display which is mountable on the rear window of a passenger automobile. Alternatively, display 375 could be the rear window itself provided that the proper display technology is included. Yet another possibility is that display 375 is a small flat screen mounted on the rear bumper of a passenger automobile or on the exterior of the back roll-up door of a commercial truck. In any case, DVD 110 can transmit information for display to display 375 either via a wired or wireless connection.

Now that the present invention and the various system components have been described, it is helpful to describe a number of possible use cases by way of example and with respect to how the system and methodologies of the present invention could be used to implement various highly targeted advertising programs. These use cases are merely examples of what can be achieved according to the teachings herein. It will be readily understood by one of skill in the art that these use cases are exemplary only and in no way limit the scope of the invention or the possible scenarios under which the present invention could be utilized.

### Use Case #1

In some jurisdictions or for other reasons, it may not be desirable and/or legal to display either still images or video in a vehicle while that vehicle is moving within traffic. In this case, it is possible to employ the teachings of the present invention to display advertisements only when the vehicle which holds the dedicated display device 110 is either stopped or driving below a certain speed.

Either or both of GPS 340 or input from vehicle via vehicle input processor 380 may be used to obtain current speed information for the vehicle and GPS 340 may be used to obtain location data. This data can be used, for example, to ensure that ads are displayed only when speed is at zero (vehicle stopped) or, for example, at a current speed of less than 15 miles per hour. In addition, location data can be used to ensure ads are displayed, if desired, only at specific locations or within specific geographic perimeters. In this way, for example, ads may be displayed by DVD 110 only when the vehicle is parked at one or more mall parking lots in the metro Washington DC area. Ads can thus be targeted, perhaps, to stores located within that mall and may be served and displayed in real time or near real time so as to permit targeted ads reflecting current specials or offers. In this embodiment, it is preferable that DVD 110 contain a battery with back up capability so that it may operate when the vehicle engine is turned off.

### Use Case #2

Another use case involves the exploitation of either or both of time and geographic data. Both are available to DVD 110 and at CCS 100 as described above. In this use case, ads may be selected for display on DVD 110 based on a vehicle being within a designated geographic zone and possible also during a certain time. As such, it is possible, for example, for an ad to be served in real time or near real time reflecting an ongoing special, offer or other advertisement relative to time and location. So for example, a local Italian restaurant could buy ads to be served only on Mondays-Fridays at between 11 am and 1 pm and only to DVDs 110 within a 3 mile radius of the geographic location of the restaurant. The ad content could, in this context, relate to specials available at that restaurant at those times.

### Use Case #3

The third use case is presented from the perspective of the vehicle owner. The flexibility of the system of the present invention as well as the diversity of information available to it allows for unique and highly targeted ad buys as well as for varying schemes for determining payment due to vehicle owners. According to this use case, a vehicle owner may sign up and agree to have ads displayed on his or her vehicle's DVD 110 such that differing bases for payment are available.

For example, an owner may receive a fixed monthly amount regardless of how many ads are displayed or where or when. Alternatively, the owner may receive payment based on the number of miles driven, routes taken, type of vehicle, model of DVD 110 used or other characteristics.

### Fixed Location Embodiment

While the present invention has been generally described in the context of DVD's 110 located in moving or at least movable vehicles, it is alternatively or additionally possible for these DVDs 110 to be located in a fixed position. For example, DVD's 110 could be permanently or semi-permanently fixed in a storefront window, at a gas station gas pump, on a city parking meter (or integrated into these devices) or any other fixed location. In addition, DVDs 110 or the functionality associated with them could be integrated into home appliances like refrigerators, washing machines or even television sets or computer monitors.

In this context, the teachings of the present invention whereby highly targeted ads can be served based on location, temperature, time and various other factors can be used to target advertisements which are periodically displayed in a home environment. Residents of the homes in which ads are served may be paid in consideration of accepting these advertisements either through an monthly or other payment tied to the number or type of ads received or possibly though a reduced/subsidized cost associated with the device (e.g. refrigerator, washing machine) housing the ad display. In this case, ads could be visual and/or may be accompanied by sound.

Ads could be selected for display and or purchased by advertisers based on the unique characteristics of the individual and/or aggregated DVDs 110. So for example, all DVDs 110 within a 15 mile radius of a specific restaurant could receive an offer for that restaurant via a display on their refrigerator during certain times of day. Other demographic data such as that obtained from the owner at the time of sign up or through implication, such as the price of the refrigerator housing the DVD 110 to provide highly targeted advertising to the desired audience. Outside of the home environment, for example, at parking meters, ads could be served at specific locations and at specific times as desired by the advertiser.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A targeted advertising system for managing advertisements displayed in vehicles comprising:
a central control system, said central control system storing at least one of said advertisements;
at least one dedicated vehicle device located in proximity to one of said vehicles, which said at least one dedicated vehicle device receives said at least one advertisement from said central control system and wherein said at least one dedicated vehicle device displays said at least one advertisement on a visual display;
wherein said at least one advertisement is selected for display on said visual display of one of said at least one dedicated vehicle devices based upon at least one characteristic associated with the said vehicle in proximity to said dedicated vehicle device.

2. The targeted advertising system of claim 1 wherein said at least one characteristic comprises the geographic location of said vehicle.

3. The targeted advertising system of claim 1 wherein said at least one characteristic comprises the current speed of said vehicle.

4. The targeted advertising system of claim 1 wherein said advertisements are classified for purchase by advertisers based upon routes travelled information associated with at least one of said vehicles.

5. The targeted advertising system of claim 4 wherein said advertisements are classified for purchase by advertisers based further upon traffic volume data.

6. The targeted advertising system of claim 1 wherein said at least one dedicated vehicle device periodically communicates data to said central control system, said data comprising updates to said least one characteristic associated with the said vehicle in proximity to said dedicated vehicle device.

7. The targeted advertising system of claim 6 wherein said central control system receives said updates and employs such updates to change the parameters associated with the inventory of said advertisements available to be purchased by advertisers.

8. A method for selectively targeting advertisements for display in vehicles comprising the steps of:
receiving information from vehicle owners;
receiving advertisements from advertisers;
receiving advertisement buys from advertisers; and
serving said advertisements to a display located proximate to said vehicles.

9. The method of claim 8 wherein said advertisements are selectively served based upon aggregated vehicle owner information received from a plurality of vehicle owners.

10. The method of claim 8 further comprising the steps of:
periodically receiving updated information from said vehicle owners; and
updating the characteristics of the available advertisement buys based upon said updated information received from said vehicle owners.

11. The method of claim 10 wherein said updated information from said vehicle owners comprises historic driving habit information.

12. The method of claim 11 wherein said historic driving habit information comprises routes previously travelled by vehicles owned by said vehicle owners.

13. An advertising system comprising:
a central control system, said central control system communicating with an advertiser database, an advertisements database and a device custodian database;
a plurality of display devices, each of said display devices associated with a device custodian, each of said display devices in communication with said central control system;
an advertiser interface permitting advertisers to provide information which is stored in said advertiser database and to make ad buys;
a device custodian interface permitting device custodians to provide information which is stored in said device custodian database;
an advertisements interface permitting advertisers to provide advertisements which are stored in said advertisements database; and
an ad serving engine which selects advertisements for display on selected of said display devices based on said ad buys made by said advertisers and said information provided by said device custodians which is stored in said device custodian database.

14. The system of claim 13 wherein said display devices provide data periodically to said device custodian database.

15. The system of claim 14 wherein said data provided by said display devices comprises data representing the location of said display device.

16. The system of claim 15 wherein at least one of said display devices is located in a fixed position.

17. The system of claim 15 wherein said at least one of said display devices is located in a movable vehicle.

18. The system of claim 13 wherein said advertisements are transmitted wirelessly to said display devices.

19. The system of claim 13 further comprising a financial settlement engine for determining payments due to said device custodians and payments due from said advertisers in respect of ads served to said plurality of display devices.

20. The system of claim 13 further comprising an advertiser engine permitting advertisers to make ad buys.
